(19) United States
(12) Patent Application Publication
(10) Pub. No.: US 2022/0261030 A1
(43) Pub. Date: Aug. 18, 2022

(54) SYSTEMS AND METHODS FOR MATRIX-VECTOR MULTIPLICATION

(71) Applicant: CORNELL UNIVERSITY, Ithaca, NY (US)

(72) Inventors: Tianyu Wang, Ithaca, NY (US); Peter McMahon, Ithaca, NY (US)

(21) Appl. No.: 17/670,232

(22) Filed: Feb. 11, 2022

Related U.S. Application Data
(60) Provisional application No. 63/149,974, filed on Feb. 16, 2021.

(51) Int. Cl. G06E 3/00

(52) U.S. Cl. CPC G06E 3/008

(57) ABSTRACT

Embodiments described herein provide systems and methods for computing matrix-vector multiplication operations. The systems and methods generally compute the matrix-vector multiplication operations using analog optical signals. The systems and methods allow completely reconfigurable multiplication operations and may be used as application specific computational hardware for deep neural networks.

### CROSS-REFERENCE

The present application claims priority to U.S. Provisional Patent Application No. 63/149,974, entitled “Device for Computing General Matrix-Vector Multiplication with Analog Optical Signals,” filed Feb. 16, 2021, which application is entirely incorporated herein by reference for all purposes.

### TECHNICAL FIELD

The present disclosure relates generally to systems and methods for computing matrix-vector multiplication operations.

### BACKGROUND

Much of the progress in deep learning over the past decade has been facilitated by the use of deep and larger models, with commensurately large computation requirements and energy consumption. Optical processors have been proposed as deep-learning accelerators that can in principle achieve better energy efficiency and lower latency than electronic processors. For deep learning, optical processors' main proposed role is to implement matrix-vector multiplications, which are typically the most computationally-intensive operations in deep neural networks. Thus, there is a need for systems and methods that utilize optical processing to implement matrix-vector multiplication operations.

### SUMMARY

The present disclosure provides systems and methods for computing matrix-vector multiplication operations. The systems and methods generally compute the matrix-vector multiplication operations using analog optical signals. The systems and methods allow completely reconfigurable multiplication operations and may be used as application specific computational hardware for deep neural networks. Matrix-vector multiplication is a fundamental numerical operation in all modern deep neural networks and constitutes the majority of the total computation in these models. Thus, the systems and methods are designed to achieve higher computational speed with lower energy consumption than electronic systems and methods. Other applications may include large-scale heuristic optimization problems, low-latency rendering in computer graphics, and simulation of physical systems.

The systems and methods generally implement a free-space optical system composed of lasers, lens, gratings, spatial light modulators (SLM), and the like to perform matrix-matrix multiplication with analog optical signals. Both coherent and incoherent light sources may be utilized. Electrical and/or optical fan-out approaches are used to make copies of a two-dimensional (2D) point source array and tile them into a larger 2D array with congruent constituent patterns.

The block design of systems and methods allows more scalable computation of large matrix-vector multiplication. For example, electrical fan-out may allow matrix-vector multiplications on any size vector with about 0.5 million multiplications in each update cycle, which is orders of magnitude higher than previously achieved. To achieve such effects, the systems and methods may utilize well-compensated spherical lens systems instead of single cylindrical lenses, allowing for large field-of-view imaging. The use of incoherent sources such as light emitting diode (LED) arrays may leverage advantages of the mature LED integration technology used for commercial displays, which allows millions of pixels in the input device. Using optical fan-out operations may enable the use of integrated coherent sources to utilize matrices having about 1 billion or more entries.

The systems and methods may achieve the theoretical energy consumption limit of less than one photon per multiplication with about 70% classification accuracy on handwritten digits. When utilizing 10 detected photons per multiplication, the systems and methods may achieve about 99% accuracy. The total optical energy required to perform the matrix-vector multiplication in an optical neural network utilizing the systems and methods may utilize less than 1 picojoule (pJ) of energy for matrix-vector multiplication using a matrix with 0.5 million entries.

In accordance with various embodiments, a method is provided. The method can comprise projecting a plurality of light signals, each light signal corresponding to a first vector element of a first vector comprising a plurality of first vector elements and having dimensionality L×1; forming M copies of the plurality of light signals; and for each copy of the plurality of light signals: applying a plurality of optical modulation weights to the plurality of first vector elements to form a plurality of weighted vector elements, the plurality of optical modulation weights corresponding to first matrix elements in a subregion of a first matrix comprising a plurality of first matrix elements and having dimensionality M×L; detecting an optical detection signal corresponding to a sum of the plurality of weighted vector elements; and outputting the optical detection signal as a second vector element of a second vector having dimensionality M×1.

In accordance with various embodiments, a system is provided. The system can comprise a light projector configured to emit a plurality of light signals, each light signal corresponding to a first vector element of a first vector comprising a plurality of first vector elements and having dimensionality L×1; a fan-out module configured to form M copies of the plurality of light signals; an optical modulator configured to, for each copy of the plurality of light signals, apply a plurality of optical modulation weights to the plurality of first vector elements to form a plurality of weighted vector elements, the plurality of optical modulation weights corresponding to first matrix elements in a subregion of a first matrix comprising a plurality of first matrix elements and having dimensionality M×L; a plurality of optical detectors configured to, for each copy of the plurality of light signals, detect an optical detection signal corresponding to a sum of the plurality of weighted vector elements; and an output module configured to, for each copy of the plurality of light signals, output the optical detection signal as a second vector element of a second vector having dimensionality M×1.

### BRIEF DESCRIPTION OF THE DRAWINGS

FIG. 1 is a conceptual diagram of a process flow for computing matrix-vector multiplication operations, in accordance with various embodiments.

FIG. 2 is a simplified exemplary diagram of a system for computing matrix-vector multiplication operations, in accordance with various embodiments.

FIG. 3 shows an example of a kaleidoscope system for use as an optical fan-out module in the system of FIG. 2, in accordance with various embodiments.

FIG. 4 shows an example of a diffractive optical element (DOE) system for use as an optical fan-out module in the system of FIG. 2, in accordance with various embodiments.

FIG. 5 shows an example of a beamsplitter array (BSA) system for use as an optical fan-out module in the system of FIG. 2, in accordance with various embodiments.

FIG. 6 shows an example of a stacked BSA system for use as an optical fan-out module in the system of FIG. 2, in accordance with various embodiments.

FIG. 7 shows an example of a micro-lens array for use as an optical fan-out module in the system of FIG. 2, in accordance with various embodiments.

FIG. 8 shows an example of a single unit of a micro-lens array for use as an optical fan-in module in the system of FIG. 2, in accordance with various embodiments.

FIG. 9 shows an example of an optical neural network (ONN) implemented using the systems and methods described herein, in accordance with various embodiments.

FIG. 10A shows an exemplary characterization of the numerical precision of dot products calculated using the systems and methods described herein, in accordance with various embodiments.

FIG. 10B shows the root-mean-square (RMS) error of the dot product computation versus the average number of detected photons per multiplication, in accordance with various embodiments.

FIG. 10C shows the RMS error versus various vector sizes, in accordance with various embodiments.

FIG. 11A shows an ONN operation composed of three fully connected layers, in accordance with various embodiments.

FIG. 11B shows classification accuracy on the MNIST dataset under varying optical energy consumption and confusion matrices of each corresponding experiment, in accordance with various embodiments.

FIG. 12 is a block diagram of a computer-based system for computing matrix-vector multiplication operations, in accordance with various embodiments.

FIG. 13 is a block diagram of a computer system, in accordance with various embodiments.

In various embodiments, not all of the depicted components in each figure may be required, and various embodiments may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

Described herein are systems and methods for computing matrix-vector multiplication operations. The systems and methods generally compute the matrix-vector multiplication operations using analog optical signals. The systems and methods allow completely reconfigurable multiplication operations and may be used as application specific computational hardware for deep neural networks. The disclosure, however, is not limited to these exemplary embodiments and applications or to the manner in which the exemplary embodiments and applications operate or are described herein.

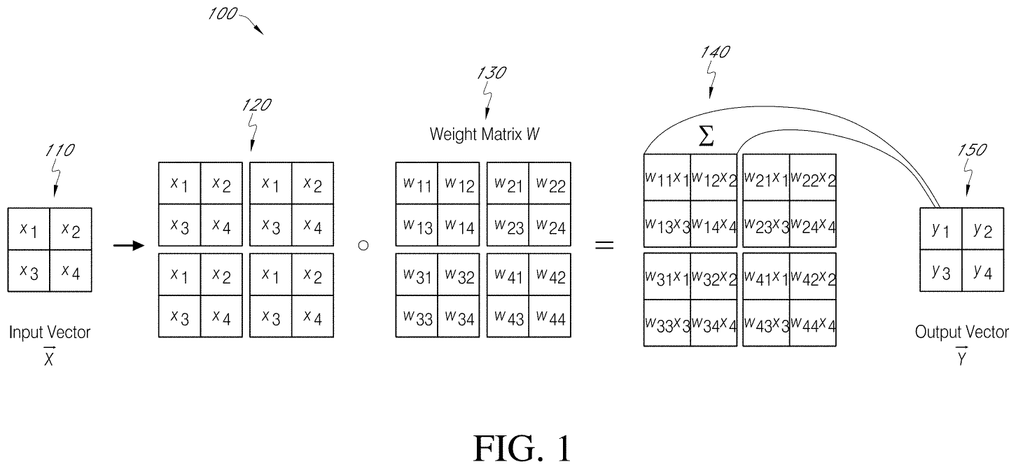

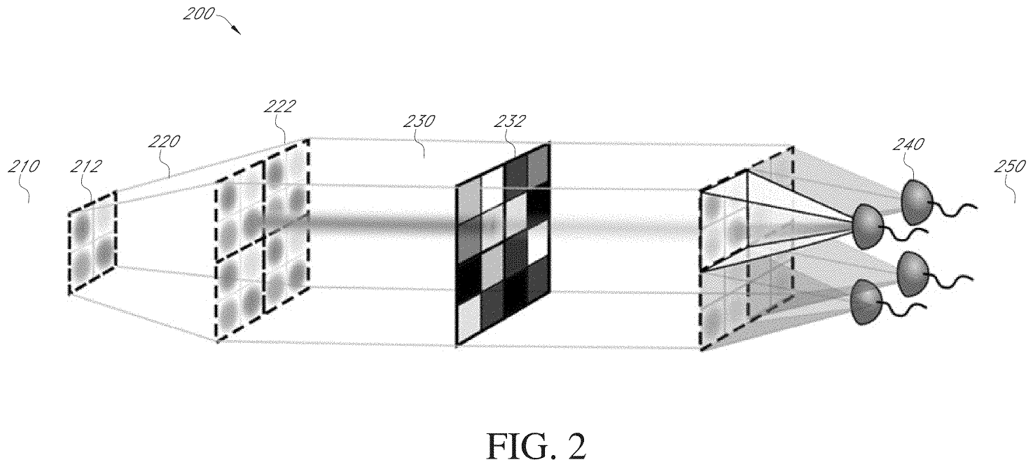

FIG. 1 is a conceptual diagram of a process flow 100 for computing matrix-vector multiplication operations, in accordance with various embodiments. According to various embodiments, the process flow comprises a first operation 110 of projecting a plurality of light signals. The plurality of light signals may comprise a plurality of incoherent light signals, as described herein with respect to FIG. 2. The plurality of light signals may comprise a plurality of coherent light signals, as described herein with respect to FIG. 2. In various embodiments, the plurality of light signals 212 encode a plurality of first vector elements of a first vector. For instance, each light signal of the plurality of light signals may have an intensity or other optical attribute that represents the numerical value of the corresponding first vector element. Thus, each light signal of the plurality of light signals may correspond to a first vector element of a first vector.

In the example shown in FIG. 1, each light signal may correspond to a vector element of a first vector \vec{x}. The first vector may have a dimensionality of L×1. In general, L may be any whole number and may have a value of at least about 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more, at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1, or a value that is within a range defined by any two of the preceding values. For example, for L=4, the first vector \vec{x} may have elements {x₁,x₂,x₃,x₄}. The elements of the first vector \vec{x} may be arranged as necessary to optimize the remaining operations of the process flow. For instance, as shown, the elements may be arranged to form a square array.

According to various embodiments, the process flow 100 comprises a second operation 120 of forming M copies of the plurality of light signals. Forming the copies may comprise optically forming the copies, as described herein with respect to any of FIG. 2, 3, 4, 5, 6, or 7. Forming the copies may comprise electronically forming the copies. In general, M may be any whole number and may have a value of at least about 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more, at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1, or a value that is within a range defined by any two of the preceding values.

According to various embodiments, the process flow 100 comprises a third operation 130 of, for each copy of the plurality of light signals, applying a plurality of optical modulation weights to the plurality of first vector elements to form a plurality of weighted vector elements. The plurality of optical modulation weights may correspond to first matrix elements in a subregion of a first matrix. Matrix multiplication may be performed on the plurality of first vector elements by applying the plurality of optical modulation weights. The plurality of optical modulation weights may be programmed by modulating the amplitude, intensity, or phase of different pixels comprising an optical modulator, as described herein with respect to FIG. 2. The first matrix may have a dimensionality of M×L. In the example shown, the first matrix is represented as a matrix W with entries {w₁₁,w₁₂,w₁₃,w₁₄,w₂₁,w₂₂,w₂₃,w₂₄,w₃₁,w₃₂,w₃₃,w₃₄,w₄₁,w₄₂,w₄₃,w₄₄}.

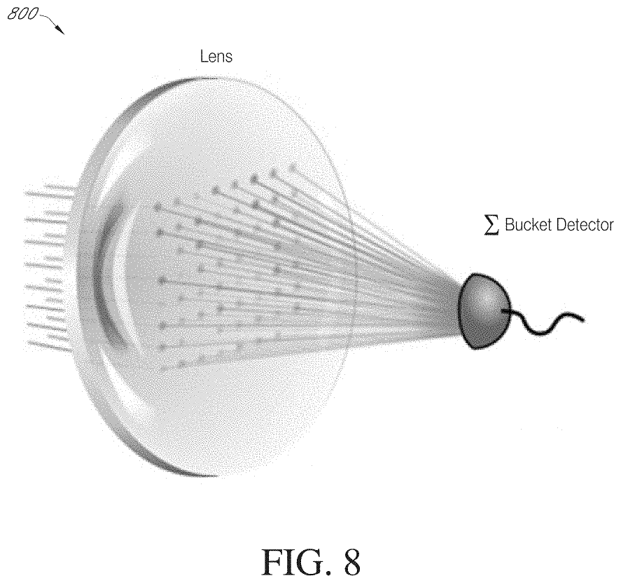

According to various embodiments, the process flow 100 comprises a fourth operation 140 of, for each copy of the plurality of light signals, detecting an optical detection signal corresponding to a sum of the plurality of weighted vector elements. The optical detection signal may be detected by directing the plurality of weighted vector elements to a detector and optically detecting the optical detection signal. The optical detection signal may be detected by optically detecting each weighted vector element to form a plurality of optical detection signals and summing the plurality of optical detection signals. The optical detection signal may be detected by utilizing an optical fan-in procedure to perform the summation operation, as described herein with respect to FIG. 2 or FIG. 8.

According to various embodiments, the process flow 100 comprises a fifth operation 150 of, for each copy of the plurality of light signals, outputting the optical detection signal as a second vector element of a second vector y. Detecting the optical detection signal may comprise directing the plurality of weighted vector elements to a detector and optically detecting the optical detection signal, as described herein with respect to FIG. 2. Detecting the optical detection signal may comprise optically detecting each weighted vector element to form a plurality of optical detection signals and summing the plurality of optical detection signals, as described herein with respect to FIG. 2. The second vector may have a dimensionality of M×1. For example, for M=4, the second vector \vec{y} may have elements {y₁,y₂,y₃,y₄}.

In various embodiments, the process flow 100 comprises an operation of, prior to projecting the plurality of light signals, receiving the first matrix and the first vector.

In various embodiments, the process flow 100 comprises an operation of, prior to projecting the plurality of light signals, arranging the plurality of first vector elements to form a two-dimensional (2D) array.

It should also be appreciated that any operation, sub-operation, step, sub-step, process, or sub-process of process flow 100 may be performed in an order or arrangement different from the embodiments illustrated by FIG. 1. For example, in other embodiments, one or more operations may be omitted or added.

In various embodiments, process flow 100 may be implemented using any of the systems or components described herein with respect to FIGS. 2-7.

FIG. 2 is a simplified exemplary diagram of a system 200 for computing matrix-vector multiplication operations, in accordance with various embodiments. According to various embodiments, the system 200 can comprise a light projector 210, a fan-out module 220, an optical modulator 230, a plurality of optical detectors 240, and an output module 250.

In accordance with various embodiments, the light projector 210 can be configured to emit a plurality of light signals 212. The light projector may comprise one or a plurality of incoherent light emitters. For example, the one or a plurality of incoherent light emitters may comprise one or an array of light emitting diodes (LEDs). The light projector may comprise one or a plurality of coherent light emitters. For instance, the one or a plurality of coherent light emitters may comprise one or an array of collimated laser light sources. In some embodiments, the plurality of light emitters directly emit the plurality of light signals. For instance, each pixel of an LED array may emit a light signal of the plurality of light signals. In other embodiments, the one or a plurality of light emitters may emit a source light (not shown in FIG. 1) which is received by an optical modulator (not shown in FIG. 1) that generates the plurality of light signals from the source light. In some embodiments, the optical modulator comprises a liquid crystal display (LCD), spatial light modulator (SLM), digital micromirror device (DMD), or any other optical modulator.

In various embodiments, the plurality of light signals 212 encode a plurality of first vector elements of a first vector. For instance, each light signal of the plurality of light signals may have an intensity or phase or other optical attribute that represents the numerical value of the corresponding first vector element. Thus, each light signal of the plurality of light signals may correspond to a first vector element of a first vector.

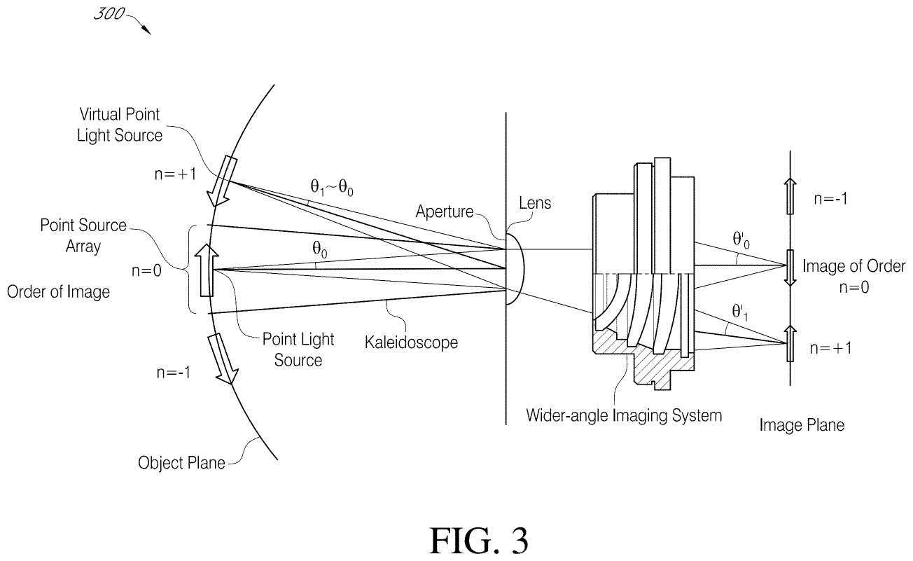

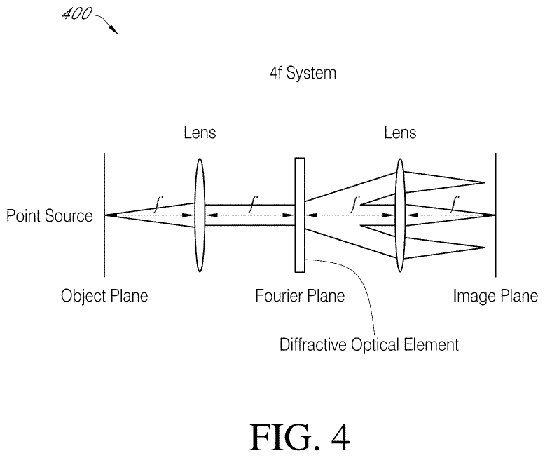

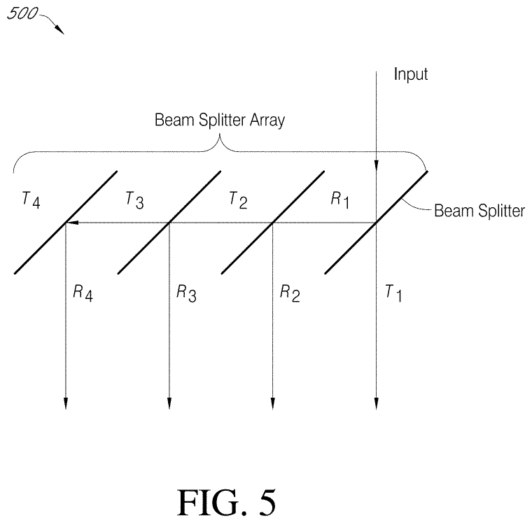

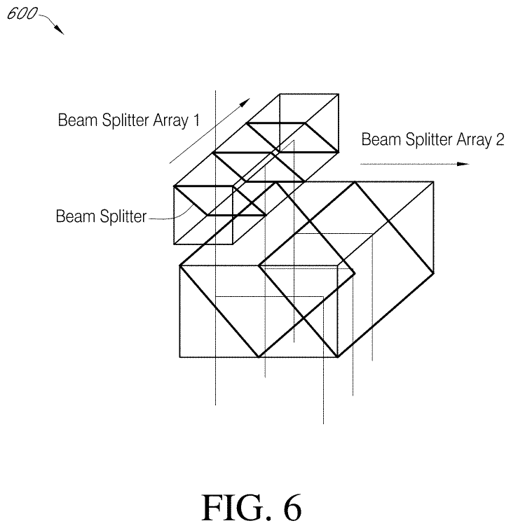

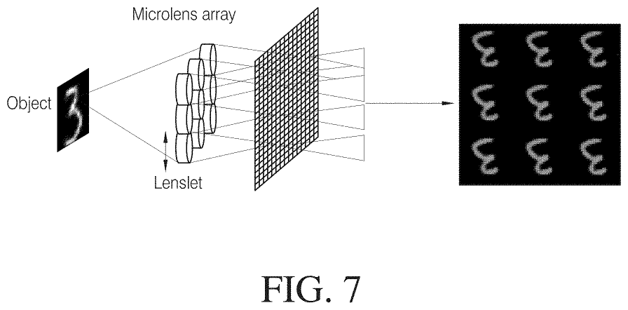

In various embodiments, the fan-out module 220 is configured to form M copies 222 of the plurality of light signals. The fan-out module may comprise an optical fan-out module. That is, the fan-out module may use optical components (such as one or more lenses, kaleidoscopes, diffractive optical elements (DOEs), or beamsplitters) and/or operations to form the copies. For example, the fan-out module may comprise a kaleidoscope-based fan-out module described herein with respect to FIG. 3, a DOE-based fan-out module described herein with respect to FIG. 4, a beamsplitter array (BSA)-based fan-out module described herein with respect to FIG. 5, or a stacked BSA-based fan-out module described herein with respect to FIG. 6, or a micro-lens-array-based module described herein with respect to FIG. 7. The fan-out module may comprise an electronic fan-out module. That is, the fan-out module may use electronic components and/or operations to form the copies.

In various embodiments, the optical modulator 230 is configured to, for each copy of the plurality of light signals, apply a plurality of optical modulation weights to the plurality of first vector elements. The optical modulator may perform multiplication on the plurality of first vector elements by applying the plurality of optical modulation weights. The plurality of optical modulation weights may be programmed by modulating the amplitude, intensity, or phase of different pixels comprising the optical modulator. The optical modulator may comprise an LCD, SLM, DMD, or any other optical modulator. Applying the plurality of modulation weights may form a plurality of weighted vector elements 232. The plurality of optical modulation weights may correspond to first matrix elements in a subregion of a first matrix. The first matrix may have a dimensionality of M×L. In general, M may be any whole number and may have a value of at least about 1, 2, 3, 4, 5, 6, 7, 8, 9, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more, at most about 1,000,000, 900,000, 800,000, 700,000, 600,000, 500,000, 400,000, 300,000, 200,000, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, 90, 80, 70, 60, 50, 40, 30, 20, 10, 9, 8, 7, 6, 5, 4, 3, 2, or 1, or a value that is within a range defined by any two of the preceding values.

In various embodiments, the plurality of optical detectors 240 are configured to, for each copy of the plurality of light signals, detect an optical detection signal corresponding to a sum of the plurality of weighted vector elements. The plurality of optical detectors may utilize an optical fan-in module to perform the summation operation. For instance, the optical fan-in module may comprise a micro-lens array, as described herein with respect to FIG. 8. Alternatively or in combination, the optical fan-in module may comprise a gradient index (GRIN) lens array, an optical diffuser, or a multimode optical fiber. Each optical detector may be configured to detect each corresponding weighted vector element for form a plurality of optical detection signals.

In various embodiments, the output module 250 is configured to, for each copy of the plurality of light signals, output the optical detection signal. The plurality of optical detection signals may correspond to a plurality of second vector elements of a second vector. The second vector may have a dimensionality of M×1.

In various embodiments, the system 200 further comprises an electronic receiving unit (not shown in FIG. 1) configured to receive the first vector and the first matrix.

In various embodiments, the system 200 further comprises an arrangement module (not shown in FIG. 1) configured to arrange the plurality of vector elements to form a 2D array prior to projecting the plurality of light signals.

In various embodiments, system 200 may be used to implement process flow 100 described herein with respect to FIG. 1.

FIG. 3 shows an example of a kaleidoscope system 300 for use as an optical fan-out module in the system 200, in accordance with various embodiments. The kaleidoscope system may utilize a tubular device (a kaleidoscope) with reflective inner surfaces that creates real or virtual images of any point source array emitting light into its cavity through reflections (single or multiple reflections). For instance, the kaleidoscope system may receive the plurality of light signals as the point source array. Depending on the reflectivity of the side walls, the kaleidoscope can make at least about 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, or more optical copies of the plurality of light signals, 100,000, 90,000, 80,000, 70,000, 60,000, 50,000, 40,000, 30,000, 20,000, 10,000, 9,000, 8,000, 7,000, 6,000, 5,000, 4,000, 3,000, 2,000, 1,000, 900, 800, 700, 600, 500, 400, 300, 200, 100, or fewer optical copies of the plurality of light signals, or a number of copies of the plurality of light signals that is within a range defined by any two of the preceding values. The kaleidoscope may be constructed from a glass tube or from a tube comprising any material that allows total internal reflection. The kaleidoscope may be constructed from one or more mirrors whose reflective sides face toward a cavity. The cavity can be filled with air or any other optically transparent material. The kaleidoscope can have a cross-section with a geometric shape that provides monohedral tiling (such as a triangular, square, or hexagonal shape, among others). The kaleidoscope may have movable walls.

The kaleidoscope system generally operate as follows. Each virtual image of the point source array may act as an optical copy of the original point source array. This may correspond to the optical fan-out operations described herein with respect to FIG. 1 or FIG. 2. The original point source array and the copies thereof may be imaged onto the image plane, where an optical modulator may be placed to perform element-wise multiplication operation. After the element-wise multiplication, any fan-in operation described herein with respect to FIG. 1, 2, or 7 may be cascaded to finish the matrix-vector multiplication.

FIG. 4 shows an example of a DOE system 400 for use as an optical fan-out module in the system 200, in accordance with various embodiments. The DOE system may utilize one or more DOEs. The one or more DOEs may comprise transparent plates that spatially modulate the phase of light impinging on them. The DOEs may be implemented using an SLM or other optical modulator, or may have a prefabricated transparency pattern. The DOEs may divide incoming light from one or more point sources (such as the plurality of light signals) into a number of copies that propagate in different directions. The DOE system may utilize a 4f optical imaging system with the one or more DOEs placed at the Fourier plane of the 4f system. This optical setup may allow copies of the plurality of light sources to be formed at the image plane.

The DOE system generally operates as follows. The one or more point sources may be imaged by a 4f system made of two lenses to the image plane. Once the one or more DOEs are inserted at the Fourier plane between the two lenses of the 4f system, multiple copies of the one or more point sources may be made in the image plane. The copies may be tiled with one another. This may correspond to the optical fan-out operations described herein with respect to FIG. 1 or FIG. 2. After the element-wise multiplication, any fan-in operation described herein with respect to FIG. 1, 2, or 7 may be cascaded to finish the matrix-vector multiplication.

FIG. 5 shows an example of a BSA system 500 for use as an optical fan-out module in the system 200, in accordance with various embodiments. The BSA system may utilize a plurality of beamsplitters. For instance, as shown in FIG. 5, the BSA system may comprise first, second, third, and fourth beamsplitters associated with first, second, third, and fourth reflectivities and transmissivities {R₁,T₁}, {R₂,T₂}, {R₃,T₃}, and {R₄,T₄}, respectively. However, the BSA system may comprise any number of beamsplitters, such as at least about 1, 2, 3, 4, 5, 6, 7, 8, 9, 10, 20, 30, 40, 50, 60, 70, 80, 90, 100, or more beamsplitters, at most about 100, 90, 80, 70, 60, 50, 40, 30, 20, 10, 9, 8, 7, 6, 5, 4, 3, 2, or 1 beamsplitters, or a number of beamsplitters that is within a range defined by any two of the preceding values. The reflectivities and transmissivities of each beamsplitter of the plurality of beamsplitters may be chosen to produce equal or nearly equal optical energies for each copy of the plurality of light signals. For instance, in the example shown in FIG. 5, choosing T₁:R₁=1:3, T₂:R₂=2:1, T₃:R₃=1:1, and T₄:R₄=0:3 may produce copies of equal or nearly equal optical energies.

FIG. 6 shows an example of a stacked BSA system 600 for use as an optical fan-out module in the system 200, in accordance with various embodiments. The stacked BSA system may comprise a first BSA system with a plurality of beamsplitters arranged along a first axis and a second BSA system with a plurality of beamsplitters arranged along a second axis. The first and second BSA systems may be similar to BSA system 500 described herein with respect to FIG. 5. By stacking the first and second BSA systems, the number of copies of the plurality of light signals may be the product of the number of beamsplitters comprising the first BSA system and the number of beamsplitters comprising the second BSA system. For example, in the example shown, using 3 beamsplitters in the first BSA system and 2 beamsplitters in the second BSA may result in 3×2=6 copies.

FIG. 7 shows an example of a micro-lens array 700 for use as an optical fan-out module in the system of FIG. 2, in accordance with various embodiments. The micro-lens array may utilize a plurality of micro-lenses. For instance, as shown in FIG. 5, the micro-lens array first, second, third, fourth, fifth, sixth, seventh, eighth, and ninth micro-lenses. However, the micro-lens array may comprise any number of micro-lenses, such as at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more micro-lenses, at most about 1,000, 900, 800, 700, 600, 500, 400, 300, 200, 100, 90, 80, 70, 60, 50, 40, 30, 20, 10, 9, 8, 7, 6, 5, 4, 3, 2, or 1 micro-lenses, or a number of micro-lenses that is within a range defined by any two of the preceding values. Each micro-lens (or lenslet) of the micro-lens array may form an optical copy of an object (such as the plurality of light signals).

FIG. 8 shows an example of a single lens unit of a micro-lens array 800 for use as an optical fan-in module in the system 200, in accordance with various embodiments. As shown, the plurality of weighted vector elements may be directed to a micro-lens of a micro-lens array (micro-lens array not shown in FIG. 8). The micro-lens may direct the plurality of weighted vector elements to a focal point of the lens. A detector may be located at the focal point of the lens and may receive plurality of weighted vector elements. A bucket detector may sum the plurality of weighted vector elements, thereby accomplishing the detection operation.

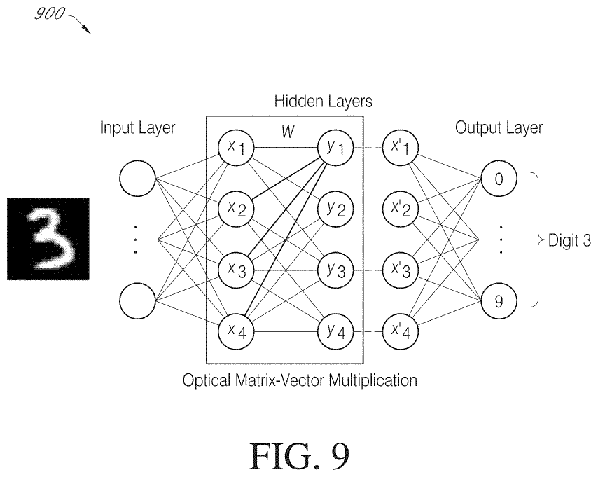

FIG. 9 shows an example of an optical neural network (ONN) 900 implemented using the systems and methods described herein. In the example shown, the first vector \vec{x} (described herein with respect to FIG. 1 and having first vector elements x₁,x₂,x₃, and x₄) forms a first hidden layer of a neural network. The second vector \vec{y} (described herein with respect to FIG. 1 and having second vector elements y₁,y₂,y₃, and y₄) forms a second hidden layer of the neural network. The first and second hidden layers are connected by weights represented by the first matrix (entries {w₁₁,w₁₂,w₁₃,w₁₄,w₂₁,w₂₂,w₂₃,w₂₄,w₃₁,w₃₂,w₃₃,w₃₄,w₄₁,w₄₂,w₄₃,w₄₄} in the example shown). During training of the ONN, the weights may be updated using procedures such as backpropagation.

### EXAMPLES

### Example 1

### An Optical Neural Network Using Less Than One Photon Per Multiplication

Here, we experimentally demonstrate a functional ONN achieving 99% accuracy in handwritten digit classification with ˜3.1 detected photons per multiplication and about 90% accuracy with ˜0.66 photon (about 2.5×10⁻¹⁹ Joules (J)) detected for each multiplication. Our design takes full advantage of the three-dimensional (3D) space for parallel processing and can perform reconfigurable matrix-vector multiplication (MVM) of arbitrary shape with a total of about 0.5 million analog multiplications per update cycle. To classify an MNIST handwritten digit image, less than 1 pJ total optical energy was required to perform all the MVMs in the ONN. Our experimental results indicate that ONNs can achieve high performance with extremely low optical energy consumption, only limited by photon shot noise.

To experimentally achieve sub-photon multiplication in optical MVM, we used a 3D free-space optical processor scalable to large matrix/vector sizes. In our design, each element xⱼ of the input vector was encoded as the intensity of a spatial mode, each created by a pixel of the light source. The input vector was spatially rearranged in a 2D block shape. The optical multiplication was performed by intensity modulation of each spatial mode, which was accomplished by replicating xⱼ to pair with its corresponding weights wᵢⱼ. After element-wise multiplication, the product terms (wᵢⱼxⱼ) were grouped and summed according to the definition of MVM: yᵢ=Σⱼwᵢⱼxⱼ, where each summation is a dot product between a row vector of the weight matrix and the input vector.

The procedure described above for MVM was implemented by three physical operations: 1) Fan-out: Copies of xⱼ were made on the light source in the 2D block arrangement. 2) Element-wise Multiplication: Each spatial mode xⱼ (and its copies) was aligned to a SLM pixel, which performed multiplication by setting the transmission of xxᵢᵢ according to weight wᵢⱼ. 3) Optical fan-in: The intensity-modulated spatial modes were physically summed by focusing onto the detector. The total number of photons received by each detector was proportional to an output element yᵢ of MVM. One of the reasons to wrap the input vectors into 2D blocks is that all the spatial modes to be summed for a dot product are already grouped in adjacency and readily focused by a single lens. This design achieved complete parallelism in the sense that all the multiplications and additions involved in the MVM took place simultaneously, and the whole MVM could be computed in a single update cycle.

To assess the scalability of the block optical MVM, we implemented the setup with an Organic Light-Emitting Diode (OLED) display with about 2 million pixels as an incoherent light source, a zoom lens as an imaging system, and a SLM of similar pixel array size as the OLED display for intensity modulation. The OLED display was imaged onto the SLM, with each OLED pixel aligned to its corresponding SLM pixel to perform element-wise multiplication. A zoom lens with continuously adjustable zoom factor was used to match the different pixel pitches of the OLED and SLM. The light field modulated by the SLM was further de-magnified and imaged onto the detectors to read out the result. Although the incoherent OLED light source only allows MVM with non-negative entries, they can be converted to real-valued vectors with little computational overhead.

Compared to SVM, another type of free-space optical MVM, our 2D block design exempted the use of cylindrical lenses for practical reasons. Cylindrical lenses are usually simple planar-convex lenses suffering from optical aberrations for large imaging angles. Our zoom lens system consisted of well-compensated spherical lens systems, which are better optimized for large field-of-view imaging than cylindrical lenses. Another advantage of our system compared to SVM was that the images used for classification tasks in machine learning are naturally in 2D. Instead of flattening a 2D image into a 1D vector, keeping its original form helped to preserve the smoothness of local feature (or reduce abrupt changes in pixel values) to avoid extra errors. With our setup, we could align about 0.5 million pixels in a region of 711×711 pixel array, which can perform the dot product between two vectors each having 0.5 million entries. In comparison, the largest MVM performed by SVM using cylindrical lenses has been limited to a vector length of 56.

The 2D block design allowed us to perform dot products between very large vectors, leading to extremely low optical energy consumption. Since the summation of dot products was performed by physically focusing photons onto the detector, the numerical precision was determined by the SNR of the detector, which is ultimately limited by photon shot noise. For a fixed numerical precision, the total number of photons received by the detector remains constant, and therefore the number of photons involved in each multiplication scales inversely with the vector size. For sufficiently large vectors, it was possible to achieve an average of less than one photon for each spatial mode while maintaining a high SNR.

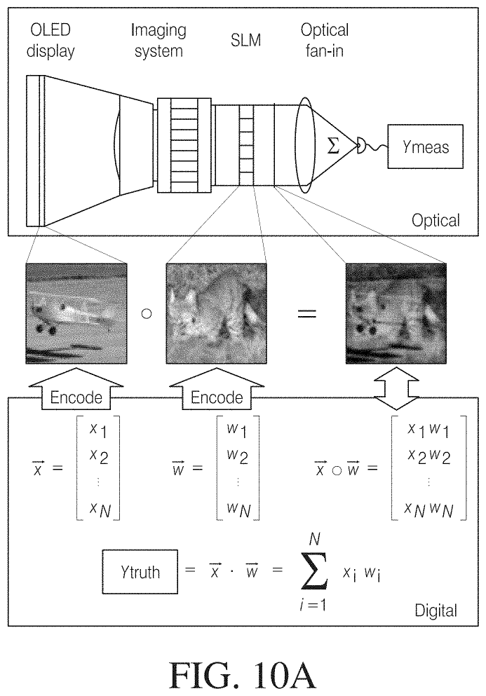

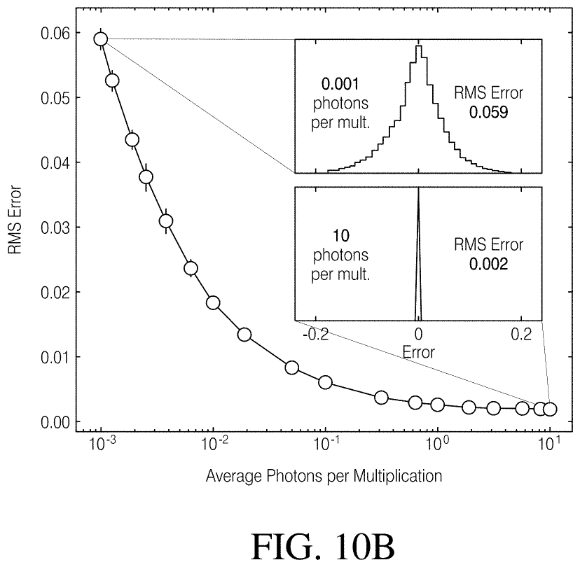

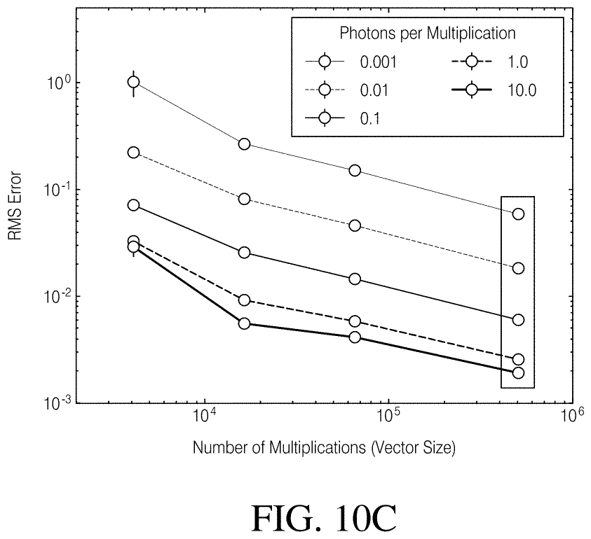

FIG. 10A shows an exemplary characterization of the numerical precision of dot products calculated using the systems and methods described herein. N-pixel images were used as test vectors by interpreting each image as an N-dimensional vector. The setup was used to compute the dot products between many different random pairs of vectors, with each computation producing a result yₘₑₐₛ (top and center rows; example experimental measurement of element-wise multiplication \vec{w} ∘ \vec{x} was captured with a camera before optical fan-in for illustrative purposes). The dot-product ground truth yₜᵣᵤₜₕ was computed on a digital computer (bottom row). The error was calculated as yₘₑₐₛ−yₜᵣᵤₜₕ. FIG. 10B shows the root-mean-square (RMS) error of the dot product computation as a function of the average number of detected photons per scalar multiplication. The vector length N was about 0.5 million (711×711). The error bars show 10 times the standard deviation of the RMS error, calculated using repeated measurements. The insets show error histograms (over different vector pairs and repeated measurements) from experiments using 10 and 0.001 photons per multiplication, respectively. FIG. 10C shows the RMS error as a function of the vector size N. For each vector size, the RMS error was computed using five different photon budgets, ranging from 0.001 to 10 photons per scalar multiplication. The shaded column indicates data points that are also shown in FIG. 10B.

To examine whether our setup could compute MVM under the photon shot noise, we quantified the numerical precision of the optical MVM under different light levels and vector sizes. We computed the dot product of vector pairs generated from randomly chosen grayscale natural scene images from the standard data set for machine learning STL10. One vector was encoded by the OLED display, and the other by SLM. The ground truth of the dot product was calculated by a digital computer, and the result of the optical computation was measured by a sensitive photodetector capable of photon counting. The optical energy (or photon counts) used for each dot product was controlled by changing the integration time of the detector signal under a constant photon flux.

We achieved a decent numerical error for large dot product computation with an extremely low photon budget. For large dot products of about 0.5 million vector length, it was possible to obtain about 6% error with only an average of 0.001 photons per multiplication. The error was mainly due to the shot noise, as the detector used for the measurement was close to shot-limited (within a factor of 2 in SNR). As we increased the number of photons spent on each multiplication, the error decreased to a minimum of about 0.2% at 2 photons per multiplication or higher. We hypothesize that the dominant sources of error at high photon counts are imperfect imaging of the OLED display pixels to SLM pixels, and crosstalk between SLM pixels. To enable comparison between the experimentally achieved analog numerical precision with the numerical precision in digital processors, we can interpret each measured analog error percentage as corresponding to an effective bit-precision for the computed dot product's answer. Using the metric noise-equivalent bits, an analog RMS error of 6% corresponds to 4 bits, and 0.2% RMS error corresponds to about 9 bits.

The same trend of decreasing numerical error with increasing photon budget was observed on shorter vector sizes. We repeated the measurement for vector sizes of 65536, 16384, and 4096. For low photon counts from 0.001 to 0.1 photons per multiplication, the numerical error was limited by 1/SNR and decreased by about 3× for every 10× increase of photon counts, regardless of the vector size. When the SNR was sufficiently high, the error stopped decreasing. This may have been due to a systematic error, as is evident from the overlap of the data points at 1 and 10 photons per multiplication. For the same numbers of photons detected per multiplication, larger vectors had a lower error by averaging out independent noise.

To compare analog numerical precision with digital ones, we converted the dot product errors to noise equivalent bits by calculating the logarithm with a base of 2. For example, 6% corresponded to −log₂(0.06)=4 bits and 0.2% led to ˜9 bits. The precision of the input vectors was determined by the intrinsic resolution of the experimental devices, i.e., 8 bits for the SLM and 7 bits for the OLED display. In our results, the analog dot product computation did not fully conserve the full numerical precision defined by the inputs, and thus led to a loss of precision. Based on Poisson statistics of shot noise, the energy advantage of optical dot products exists when the dynamic range of the output is no larger than the input. Since it has been postulated and simulated that DNNs can be trained to tolerate a certain level loss of precision in MVM, more energy savings can be achieved by taking advantage of this property.

To determine to what extent ONNs can tolerate the numerical error originating from photon noise, we trained an artificial neural network (ANN) for image classification and used our setup to perform the entire optical MVM of the model with gradually decreasing photon budgets. Due to the potential cascading of error from layer to layer, the performance of ONN could not be simply inferred from the numerical precision of MVMs. We used handwritten digits (MNIST dataset) as a benchmark and trained a 4-layer fully connected ANN with the standard back-propagation algorithm. We found that, with the intrinsic float resolution on a digital computer, the trained ANN was sensitive to the reduced numerical precision caused by photon noise. Therefore, we trained an ANN with 4-bit activation precision with Quantization-Aware Training, which was well within the intrinsic numerical precision of the setup. The trained ANN was loaded onto the ONN to perform inference on the MNIST test dataset. At the output of each layer, we read out the MVM results with a controlled number of photons used for each multiplication. After applying bias terms and nonlinear activation functions digitally, the activation of the previous layer was used as the input to the next layer.

We evaluated the first 130 test samples of the MNIST dataset under 5 different photon budgets at 0.03, 0.16, 0.32, 0.66, and 3.1 photons per multiplication. We found that 3.1 photons per multiplication offered sufficient numerical accuracy that led to a high accuracy of ˜99%, which is similar to the performance of ANNs executed on digital computers. In the sub-photon regime, using 0.66 photons per multiplication, the ONN achieved 90% classification accuracy. The experimental results agree reasonably with the results from simulations of the same neural network being executed by an ONN that is subject to simulated shot noise only. The reported accuracies were obtained with single-shot execution of the neural network without any repetition. To achieve an accuracy of 99%, the detected optical energy per inference of a handwritten digit was ˜107 femtojoules (fJ). For the weight matrices used in these experiments, the average SLM transmission was ˜46%, so when considering the unavoidable loss at the SLM, the total optical energy needed for each inference was ˜230 fJ. For comparison, this energy is less than the energy typically used for only a single float-point scalar multiplication in electronic processors, and our model required 90,384 scalar multiplications per inference. Each optical operation simply replaces a corresponding operation in the digital version of the same fully trained neural network.

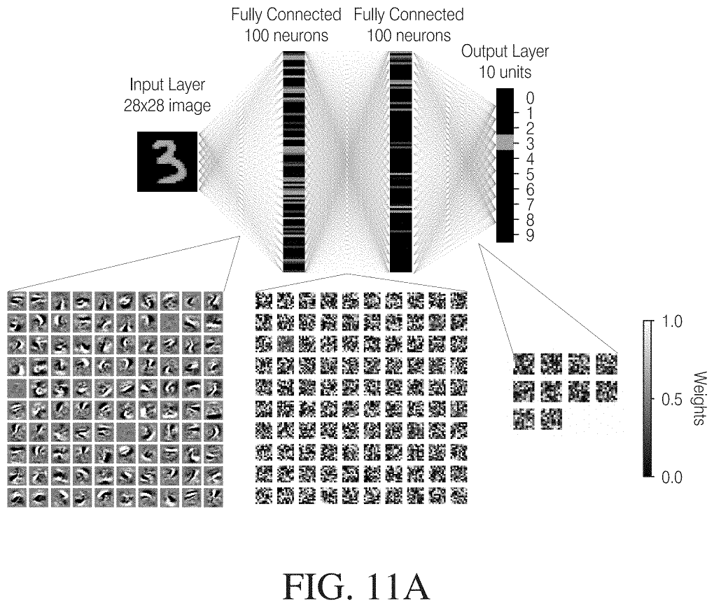

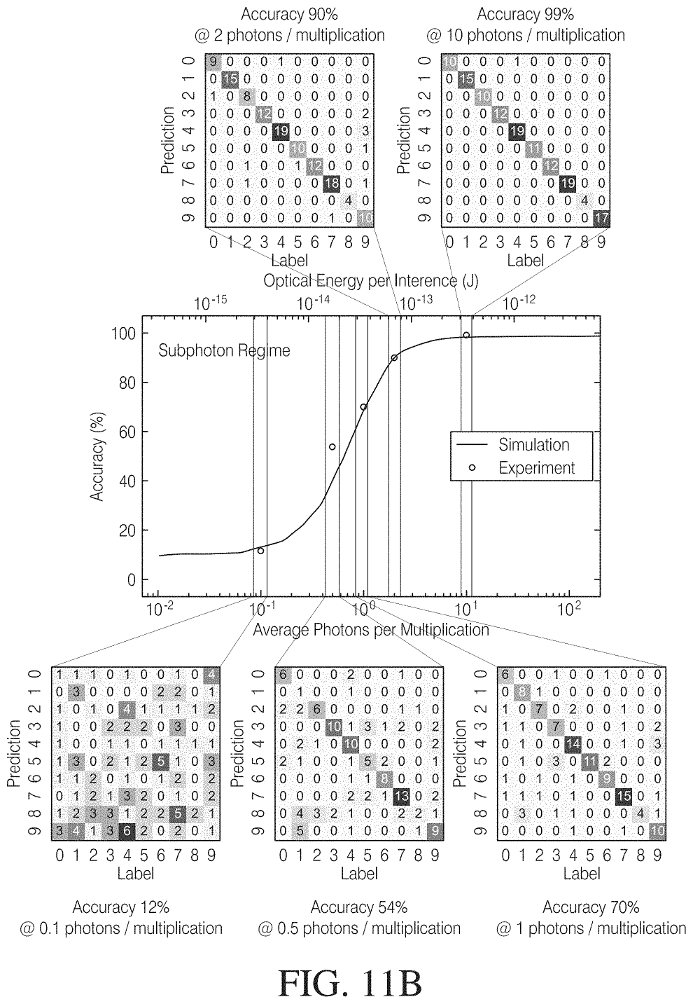

FIG. 11A shows a 4-layer neural network for handwritten-digit classification that we implemented as an ONN. Top panel: the neural network is composed of a sequence of fully connected layers represented as either a block (input image) or vertical bar (hidden and output layers) comprising green pixels, the brightness of which is proportional to the activation of each neuron. The weights of the connections between neurons for all four layers are visualized; the pixel values in each square array (bottom panel) indicate the weights from all the neurons in one layer to one of the neurons in the next layer. FIG. 11B shows classification accuracy tested using the MNIST dataset as a function of optical energy consumption (middle panel), and confusion matrices of each corresponding experiment data point (top and bottom panels). The detected optical energy per inference is defined as the total optical energy received by the photodetector during execution of the three matrix-vector multiplications comprising a single forward pass through the entire neural network.

### Example 2

### Methods for Constructing and Training an ONN

We used the OLED display of an Android phone (Google Pixel 2016) as the incoherent light source for encoding input vectors in our experimental setup. Only green pixels (with an emission spectrum centered around 525 nm) were used in the experiments; the OLED display contains an array of about 2 million (1920×1080) green pixels that can be refreshed at 60 Hz at most. Custom Android software was developed to load bitmap images onto the OLED display through Python scripts running on a control computer. The phone was found capable of displaying 124 distinct brightness levels (˜7 bits) in a linear brightness ramp. At the beginning of each matrix-vector-multiplication computation, the vector was reshaped into a 2D block and displayed as an image on the phone screen for the duration of the computation. The brightness of each OLED pixel was set to be proportional to the value of the non-negative vector element it encoded. Fan-out of the vector elements was performed by duplicating the vector block on the OLED display.

Scalar multiplication of vector elements with non-negative numbers was performed by intensity modulation of the light that was emitted from the OLED pixels. An intensity-modulation module was implemented by combining a phase-only reflective liquid-crystal spatial light modulator (SLM, P1920-500-1100-HDMI, Meadowlark) with a polarizing beam splitter and a half-wave plate in a double-pass configuration. An intensity look-up table (LUT) was created to map SLM pixel values to transmission percentages, with an 8-bit resolution.

Element-wise multiplication between two vectors \vec{w} and \vec{x} was performed by aligning the image of each OLED pixel (encoding an element of \vec{x}) to its counterpart pixel on the SLM (encoding an element of \vec{w}). By implementing such pixel-to-pixel alignment, as opposed to aligning patches of pixels to patches of pixels, we maximized the size of the matrix-vector multiplication that could be performed by this setup. A zoom-lens system (Resolve 4K, Navitar) was employed to de-magnify the image of the OLED pixels by about 0.16× to match the pixel pitch of the SLM. The image of each OLED pixel was diffraction-limited with a spot diameter of about 6.5 μm, which is smaller than the 9.2 μm size of pixels in the SLM, to avoid crosstalk between neighboring pixels. Pixel-to-pixel alignment was achieved for about 0.5 million pixels. This enabled the setup to perform vector-vector dot products with 0.5-million-dimensional vectors in single passes of light through the setup. The optical fan-in operation was performed by focusing the modulated light field onto a detector, through a 4f system consisting of the rear adapter of the zoom-lens system and an objective lens (XLFLUOR4×/340, NA=0.28, Olympus).

The detector measured optical power by integrating the photon flux impinging on the detector's active area over a specified time window. Different types of detector were employed for different experiments. A multi-pixel photon counter (MPPC, C13366-3050GA, Hamamatsu) was used as a bucket detector for low-light-level measurements. This detector has a large dynamic range (pW to nW) and moderately high bandwidth (about 3 MHz). The MPPC outputted a single voltage signal representing the integrated optical energy of the spatial modes focused onto the detector area by the optical fan-in operation. The MPPC is capable of resolving the arrival time of single-photon events for low photon fluxes (<10⁶ per second); for higher fluxes that exceed the bandwidth of MPPC (about 3 MHz), the MPPC output voltage is proportional to the instantaneous optical power. The SNR of the measurements made with the MPPC was roughly half of the SNR expected for a shot-noise-limited measurement. The integration time of the MPPC was set between 100 ns and 1 ms for the experiments shown in FIGS. 10A-C, and between 1 μs to 60 μs for the experiments shown in FIGS. 11A-B. Since the MPPC does not provide spatial resolution within its active area, it effectively acts as a single-pixel detector and consequently could only be used to read out one dot product at a time. For parallel computation of multiple dot products (as is desirable when performing matrix-vector multiplications that are decomposed into many vector-vector dot products), a CMOS camera (Moment-95B, monochromatic, Teledyne) was used. The intensity of the modulated light field was captured by the camera as an image, which was divided into regions of interest (ROIs), each representing the result of an element-wise product of two vectors. The pixels in each ROI could be then summed digitally to obtain the total photon counts, which correspond to the value of the dot product between the two vectors. Compared to the MPPC, the CMOS camera was able to capture the spatial distribution of the modulated light but could not be used for the low-photon-budget experiments due to its much higher readout noise (about 2 electrons per pixel) and long frame-exposure time (≥10 μs). Consequently the camera was only used for setup alignment and for visualizing the element-wise products of two vectors with large optical powers, and the MPPC was used for the principal experiments in this work—vector-vector dot-product calculation and matrix-vector multiplication involving low numbers of photons per scalar multiplication.

The numerical accuracy of dot products was characterized with pairs of vectors consisting of non-negative elements; since there is a straightforward procedural modification to handle vectors whose elements are signed numbers, the results obtained are general. The dot-product answers were normalized such that the answers for all the vector pairs used fall between 0 and 1; this normalization was performed such that the difference between true and measured answers could be interpreted as the achievable accuracy in comparison to the full dynamic range of possible answer. Before the accuracy-characterization experiments were performed, the setup was calibrated by recording the output of the detector for many different pairs of input vectors and fitting the linear relationship between the dot-product answer and the detector's output.

The vector pairs used for accuracy characterization were generated from randomly chosen grayscale natural-scene images (STL-10 dataset. The error of each computed dot product was defined as the difference between the measured dot-product result and the ground truth calculated by a digital computer. The number of photons detected for each dot product was tuned by controlling the integration time window of the detector. The measurements were repeated many times to capture the error distribution resulting from noise. For each vector size, the dot products for 100 vector pairs were computed. The root-mean-square (RMS) error was calculated based on data collected for different vector pairs and multiple measurement trials. Therefore, the RMS error includes contributions from both the systematic error and trial-to-trial error resulting from noise. The RMS error can be interpreted as the “expected” error from a single-shot computation of a dot product with the setup. The noise equivalent bits were calculated using the formula NEB=−log₂ (RMS Error).

To perform handwritten-digit classification, we trained a neural network with 4 fully connected layers. The input layer consists of 784 neurons, corresponding to the 28×28=784 pixels in grayscale images of handwritten digits. This is followed by two fully connected hidden layers with 100 neurons each. We used ReLU as the nonlinear activation function. The output layer has 10 neurons; each neuron corresponds to a digit from 0 to 9, and the prediction of which digit is contained in the input image is made based on which of the output neurons had the largest value. The neural network was implemented and trained in PyTorch. The training of the neural network was conducted exclusively on a digital computer (our optical experiments perform neural-network inference only). To improve the robustness of the model against numerical error, we employed quantization-aware training (QAT), which was set to quantize the activations of neurons to 4 bits and weights to 5 bits. In addition, we performed data augmentation: we applied small random affine transformations and convolutions to the input images during training. This is a technique in neural-network training for image-classification tasks to avoid overfitting and intuitively should also improve the model's tolerance to potential hardware imperfections (e.g., image distortion and blurring). The training methods used not only effectively improved model robustness against numerical errors but also helped to reduce the optical energy consumption during inference. We note that the 4-bit quantization of neuron activations was only performed during training, and not during the inference experiments conducted with the optical setup: the activations were loaded onto the OLED display using the full available precision (7 bits).

To execute the trained neural network with the optical vector-vector dot product multiplier, we needed to perform 3 different matrix-vector multiplications, each responsible for the forward propagation from one layer to the next. The weights of each matrix of the MLP model were loaded onto the SLM, and the vector encoding the neuron values for a particular layer was loaded onto the OLED display. We performed matrix-vector multiplication as a set of vector-vector dot products. For each vector-vector dot product, the total photon counts (or optical energy) measured by the detector were mapped to the answer of the dot product through a predetermined calibration curve. The calibration curve was made using the first 10 samples of the MNIST test dataset by fitting the measured photon counts to the ground truth of the dot products. The number of photons per multiplication was controlled by adjusting the detector's integration time. The measured dot-product results were communicated to a digital computer where bias terms were added and the nonlinear activation function (ReLU) was applied. The resulting neuron activations of each hidden layer were used as the input vector to the matrix-vector multiplication for the next weight matrix. At the output layer, the prediction was made in a digital computer based on the neuron with the highest value.

### Computer Implemented Methods

In various embodiments, at least a portion of the methods for computing matrix-vector multiplications can be implemented via software, hardware, firmware, or a combination thereof.

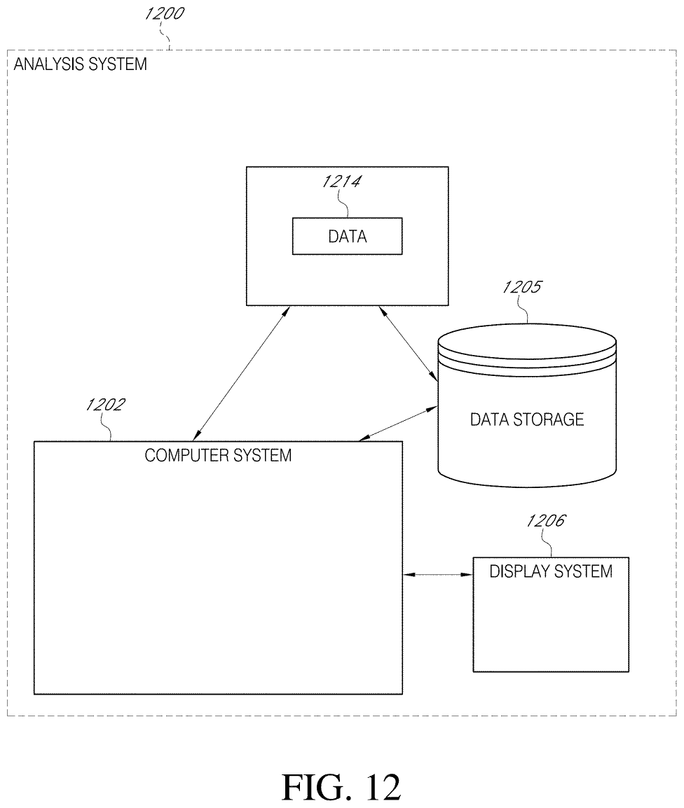

That is, as depicted in FIG. 12, the methods and systems disclosed herein can be implemented on a computer-based system 1200 for computing matrix-vector multiplications. The system 1200 may comprise a computer system such as computer system 1202 (e.g., a computing device/analytics server). In various embodiments, the computer system 1202 can be communicatively connected to a data storage 1205 and a display system 1206 via a direct connection or through a network connection (e.g., LAN, WAN, Internet, etc.). The computer system 1202 can be configured to receive data, such as image feature data described herein. It should be appreciated that the computer system 1202 depicted in FIG. 12 can comprise additional engines or components as needed by the particular application or system architecture.

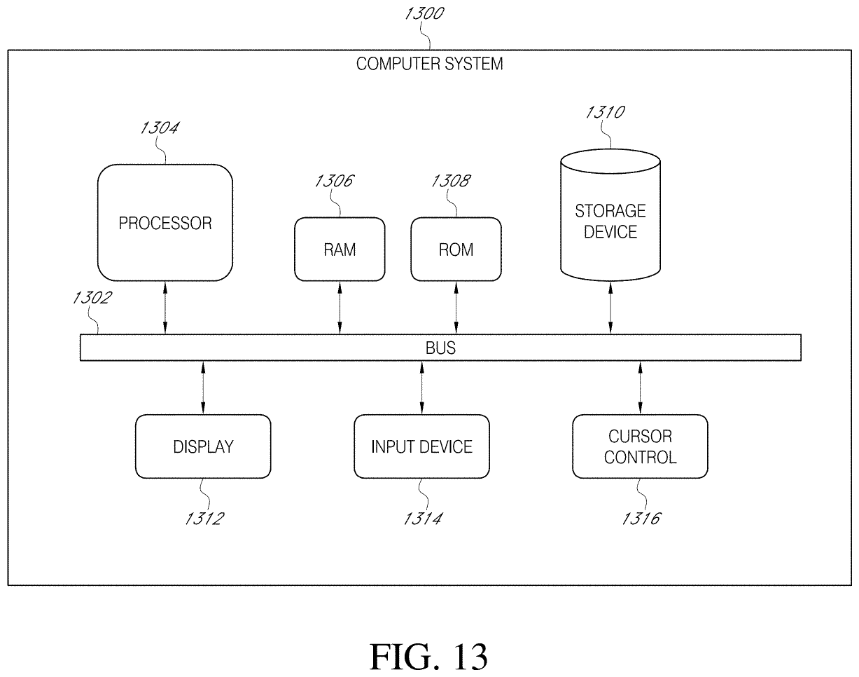

FIG. 13 is a block diagram of a computer system in accordance with various embodiments. Computer system 1300 may be an example of one implementation for computer system 1202 described herein with respect to FIG. 12. In one or more examples, computer system 1300 can include a bus 1302 or other communication mechanism for communicating information, and a processor 1304 coupled with bus 1302 for processing information. In various embodiments, computer system 1300 can also include a memory, which can be a random-access memory (RAM) 1306 or other dynamic storage device, coupled to bus 1302 for determining instructions to be executed by processor 1304. Memory also can be used for storing temporary variables or other intermediate information during execution of instructions to be executed by processor 1304. In various embodiments, computer system 1300 can further include a read only memory (ROM) 1308 or other static storage device coupled to bus 1302 for storing static information and instructions for processor 1304. A storage device 1310, such as a magnetic disk or optical disk, can be provided and coupled to bus 1302 for storing information and instructions.

In various embodiments, computer system 1300 can be coupled via bus 1302 to a display 1312, such as a cathode ray tube (CRT) or liquid crystal display (LCD), for displaying information to a computer user. An input device 1314, including alphanumeric and other keys, can be coupled to bus 1302 for communicating information and command selections to processor 1304. Another type of user input device is a cursor control 1316, such as a mouse, a joystick, a trackball, a gesture input device, a gaze-based input device, or cursor direction keys for communicating direction information and command selections to processor 1304 and for controlling cursor movement on display 1312. This input device 1314 typically has two degrees of freedom in two axes, a first axis (e.g., x) and a second axis (e.g., y), that allows the device to specify positions in a plane. However, it should be understood that input devices 1312 allowing for three-dimensional (e.g., x, y and z) cursor movement are also contemplated herein.

Consistent with certain implementations of the present teachings, results can be provided by computer system 1300 in response to processor 1304 executing one or more sequences of one or more instructions contained in RAM 1306. Such instructions can be read into RAM 1306 from another computer-readable medium or computer-readable storage medium, such as storage device 1310. Execution of the sequences of instructions contained in RAM 1306 can cause processor 1304 to perform the processes described herein. Alternatively, hard-wired circuitry can be used in place of or in combination with software instructions to implement the present teachings. Thus, implementations of the present teachings are not limited to any specific combination of hardware circuitry and software.

The term “computer-readable medium” (e.g., data store, data storage, storage device, data storage device, etc.) or “computer-readable storage medium” as used herein refers to any media that participates in providing instructions to processor 1304 for execution. Such a medium can take many forms, including but not limited to, non-volatile media, volatile media, and transmission media. Examples of non-volatile media can include, but are not limited to, optical, solid state, magnetic disks, such as storage device 1310. Examples of volatile media can include, but are not limited to, dynamic memory, such as RAM 1306. Examples of transmission media can include, but are not limited to, coaxial cables, copper wire, and fiber optics, including the wires that comprise bus 1302.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

In addition to computer readable medium, instructions or data can be provided as signals on transmission media included in a communications apparatus or system to provide sequences of one or more instructions to processor 1304 of computer system 1300 for execution. For example, a communication apparatus may include a transceiver having signals indicative of instructions and data. The instructions and data are configured to cause one or more processors to implement the functions outlined in the disclosure herein. Representative examples of data communications transmission connections can include, but are not limited to, telephone modem connections, wide area networks (WAN), local area networks (LAN), infrared data connections, NFC connections, optical communications connections, etc.

It should be appreciated that the methodologies described herein, flow charts, diagrams, and accompanying disclosure can be implemented using computer system 1300 as a standalone device or on a distributed network of shared computer processing resources such as a cloud computing network.

The methodologies described herein may be implemented by various means depending upon the application. For example, these methodologies may be implemented in hardware, firmware, software, or any combination thereof. For a hardware implementation, the processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

In various embodiments, the methods of the present teachings may be implemented as firmware and/or a software program and applications written in conventional programming languages such as C, C++, Python, etc. If implemented as firmware and/or software, the embodiments described herein can be implemented on a non-transitory computer-readable medium in which a program is stored for causing a computer to perform the methods described above. It should be understood that the various engines described herein can be provided on a computer system, such as computer system 1300, whereby processor 1304 would execute the analyses and determinations provided by these engines, subject to instructions provided by any one of, or a combination of, the memory components RAM 1306, ROM 1308, or storage device 1310 and user input provided via input device 1234.

### Recitation of Embodiments

### Embodiment 1

A method comprising: projecting a plurality of light signals, each light signal corresponding to a first vector element of a first vector comprising a plurality of first vector elements and having dimensionality L×1; forming M copies of the plurality of light signals; and for each copy of the plurality of light signals: applying a plurality of optical modulation weights to the plurality of first vector elements to form a plurality of weighted vector elements, the plurality of optical modulation weights corresponding to first matrix elements in a subregion of a first matrix comprising a plurality of first matrix elements and having dimensionality M×L; detecting an optical detection signal corresponding to a sum of the plurality of weighted vector elements; and outputting the optical detection signal as a second vector element of a second vector having dimensionality M×1.

### Embodiment 2

The method of EMBODIMENT 1, wherein the plurality of light signals comprises a plurality of incoherent light signals.

### Embodiment 3

The method of EMBODIMENTS 1 or 2, wherein the plurality of light signals comprises a plurality of coherent light signals.

### Embodiment 4

The method of any one of EMBODIMENTS 1-3, wherein the forming the M copies of the plurality of light signals comprises optically forming M copies of the plurality of light signals.

### Embodiment 5

The method of any one of EMBODIMENTS 1-4, wherein the forming the M copies of the plurality of light signals comprises electronically forming M copies of the plurality of light signals.

### Embodiment 6

The method of any one of EMBODIMENTS 1-5, wherein the detecting the optical detection signal comprises directing the plurality of weighted vector elements to a detector and optically detecting the optical detection signal.

### Embodiment 7

The method of any one of EMBODIMENTS 1-6, wherein the detecting the optical detection signal comprises optically detecting each weighted vector element to form a plurality of optical detection signals and summing the plurality of optical detection signals.

### Embodiment 8

The method of any one of EMBODIMENTS 1-7, wherein L is at least 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, or 1,000,000.

### Embodiment 9

The method of any one of EMBODIMENTS 1-8, further comprising, prior to the projecting the plurality of light signals: receiving the matrix and receiving the vector.

### Embodiment 10

The method of any one of EMBODIMENTS 1-9, further comprising, prior to the projecting the plurality of light signals: arranging the plurality of vector elements to form a two-dimensional (2D) array.

### Embodiment 11

A system comprising: a light projector configured to emit a plurality of light signals, each light signal corresponding to a first vector element of a first vector comprising a plurality of first vector elements and having dimensionality L×1; a fan-out module configured to form M copies of the plurality of light signals; an optical modulator configured to, for each copy of the plurality of light signals, apply a plurality of optical modulation weights to the plurality of first vector elements to form a plurality of weighted vector elements, the plurality of optical modulation weights corresponding to first matrix elements in a subregion of a first matrix comprising a plurality of first matrix elements and having dimensionality M×L; a plurality of optical detectors configured to, for each copy of the plurality of light signals, detect an optical detection signal corresponding to a sum of the plurality of weighted vector elements; and an output module configured to, for each copy of the plurality of light signals, output the optical detection signal as a second vector element of a second vector having dimensionality M×1.

### Embodiment 12

The system of EMBODIMENT 11, wherein the light projector comprises a plurality of incoherent light emitters.

### Embodiment 13

The system of EMBODIMENTS 11 or 12, wherein the light projector comprises a plurality of coherent light emitters.

### Embodiment 14

The system of any one of EMBODIMENTS 11-13, wherein the fan-out module comprises an optical fan-out module.

### Embodiment 15

The system of EMBODIMENT 14, wherein the optical fan-out module comprises one or more lenses, kaleidoscopes, diffractive optical elements, or beam splitters.

### Embodiment 16

The system of any one of EMBODIMENTS 11-15, wherein the fan-out module comprises an electronic fan-out module.

### Embodiment 17

The system of any one of EMBODIMENTS 11-16, wherein each optical detector is configured to detect the corresponding optical detection signal.

### Embodiment 18

The system of any one of EMBODIMENTS 11-17, wherein each optical detector is configured to detect each corresponding weighted vector element to form a plurality of optical detection signals.

### Embodiment 19

The system of any one of EMBODIMENTS 11-18, wherein L is at least 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, or 1,000,000.

### Embodiment 20

The system of any one of EMBODIMENTS 11-19, further comprising an electronic receiving unit configured to receive the matrix and to receive the vector.

### Embodiment 21

The system of any one of EMBODIMENTS 11-20, further comprising an arrangement module configured to arrange the plurality of vector elements to form a two-dimensional (2D) array prior to projecting the plurality of light signals.

### Embodiment 22

A system comprising: a light projector configured to emit a plurality of light signals, each light signal corresponding to a first vector element of a first vector comprising a plurality of first vector elements and having dimensionality L×1; a fan-out module configured to form M copies of the plurality of light signals; an optical modulator configured to, for each copy of the plurality of light signals, apply a plurality of optical modulation weights to the plurality of first vector elements to form a plurality of weighted vector elements, the plurality of optical modulation weights corresponding to first matrix elements in a subregion of a first matrix comprising a plurality of first matrix elements and having dimensionality M×L; a plurality of optical detectors configured to, for each copy of the plurality of light signals, detect an optical detection signal corresponding to a sum of the plurality of weighted vector elements; and an output module configured to, for each copy of the plurality of light signals, output the optical detection signal as a second vector element of a second vector having dimensionality M×1.

### Embodiment 23

The system of EMBODIMENT 22, wherein the light projector comprises a plurality of incoherent light emitters or a plurality of coherent light emitters.

### Embodiment 24

The system of EMBODIMENT 22 or 23, wherein the fan-out module comprises an optical fan-out module.

### Embodiment 25

The system of EMBODIMENT 24, wherein the optical fan-out module comprises one or more lenses, kaleidoscopes, diffractive optical elements, beam splitters or micro-lens arrays.

### Embodiment 26

The system of any one of EMBODIMENTS 22 to 25, wherein the fan-out module comprises an electronic fan-out module.

### Embodiment 27

The system of any one of EMBODIMENTS 22 to 26, wherein each optical detector is configured to detect the corresponding optical detection signal.

### Embodiment 28

The system of any one of EMBODIMENTS 22 to 27, wherein each optical detector is configured to detect each corresponding weighted vector element to form a plurality of optical detection signals.

### Embodiment 29

The system of any one of EMBODIMENTS 22 to 28, further comprising an electronic receiving unit configured to receive the matrix and to receive the vector.

### Embodiment 30

A system comprising: a light projector configured to emit a plurality of light signals, each light signal corresponding to a first vector element of a first vector comprising a plurality of first vector elements and having dimensionality L×1; an optical fan-out module configured to form M copies of the plurality of light signals; an optical modulator configured to, for each copy of the plurality of light signals, apply at least one modulation weight to the plurality of first vector elements to form a plurality of weighted vector elements, the at least one optical modulation weight corresponding to at least one first matrix element in a subregion of a first matrix comprising a plurality of first matrix elements and having dimensionality M×L; a plurality of optical detectors configured to, for each copy of the plurality of light signals, detect an optical detection signal corresponding to a sum of the plurality of weighted vector elements; and an output module configured to, for each copy of the plurality of light signals, output the optical detection signal as a second vector element of a second vector having dimensionality M×1.

### Embodiment 31

The system of EMBODIMENT 30, wherein the light projector comprises a plurality of incoherent light emitters or a plurality of coherent light emitters.

### Embodiment 32

The system of any one of EMBODIMENTS 30 or 31, wherein the optical fan-out module comprises one or more lenses, kaleidoscopes, diffractive optical elements, beam splitters, or micro-lens arrays.

### Embodiment 33

The system of any one of EMBODIMENTS 30 to 32, wherein each optical detector is configured to detect the corresponding optical detection signal.

### Embodiment 34

The system of any one of EMBODIMENTS 30 to 33, wherein each optical detector is configured to detect each corresponding weighted vector element to form a plurality of optical detection signals.

### Embodiment 35

The system of any one of EMBODIMENTS 30 to 34, further comprising an electronic receiving unit configured to receive the matrix and to receive the vector.

### Embodiment 36

A system comprising: an electronic receiving unit configured to receive a first matrix comprising a plurality of first matrix elements and having a dimensionality M×L and to receive a first vector comprising a plurality of first vector elements and having dimensionality L×1; a light projector configured to emit a plurality of light signals, each light signal corresponding to a first vector element of a first vector; a fan-out module configured to form M copies of the plurality of light signals; an optical modulator configured to, for each copy of the plurality of light signals, apply at least one modulation weight to the plurality of first vector elements to form a plurality of weighted vector elements, the at least one optical modulation weight corresponding to at least one first matrix element in a subregion of the first matrix; a plurality of optical detectors configured to, for each copy of the plurality of light signals, detect an optical detection signal corresponding to a sum of the plurality of weighted vector elements; and an output module configured to, for each copy of the plurality of light signals, output the optical detection signal as a second vector element of a second vector having dimensionality M×1.

### Embodiment 37

The system of EMBODIMENT 36, wherein the light projector comprises a plurality of incoherent light emitters or a plurality of coherent light emitters.

### Embodiment 38

The system of EMBODIMENTS 36 or 37, wherein the fan-out module comprises an optical fan-out module.

### Embodiment 39

The system of any one of EMBODIMENTS 36 to 38, wherein the optical fan-out module comprises one or more lenses, kaleidoscopes, diffractive optical elements, or beam splitters.

### Embodiment 40

The system of any one of EMBODIMENTS 36 to 39, wherein each optical detector is configured to detect the corresponding optical detection signal.

### Embodiment 41

The system of any one of EMBODIMENTS 36 to 40, wherein each optical detector is configured to detect each corresponding weighted vector element to form a plurality of optical detection signals.

Although specific embodiments and applications of the disclosure have been described in this specification, these embodiments and applications are exemplary only, and many variations are possible.

What is claimed is:

1. A system comprising:
a light projector configured to emit a plurality of light signals, each light signal corresponding to a first vector element of a first vector comprising a plurality of first vector elements and having dimensionality L×1;
a fan-out module configured to form M copies of the plurality of light signals;
an optical modulator configured to, for each copy of the plurality of light signals, apply a plurality of optical modulation weights to the plurality of first vector elements to form a plurality of weighted vector elements, the plurality of optical modulation weights corresponding to first matrix elements in a subregion of a first matrix comprising a plurality of first matrix elements and having dimensionality M×L;
a plurality of optical detectors configured to, for each copy of the plurality of light signals, detect an optical detection signal corresponding to a sum of the plurality of weighted vector elements; and
an output module configured to, for each copy of the plurality of light signals, output the optical detection signal as a second vector element of a second vector having dimensionality M×1.

2. The system of claim 1, wherein the light projector comprises a plurality of incoherent light emitters or a plurality of coherent light emitters.

3. The system of claim 1, wherein the fan-out module comprises an optical fan-out module.

4. The system of claim 3, wherein the optical fan-out module comprises one or more lenses, kaleidoscopes, diffractive optical elements, or beam splitters.

5. The system of claim 1, wherein the fan-out module comprises an electronic fan-out module.

6. The system of claim 1, wherein each optical detector is configured to detect the corresponding optical detection signal.

7. The system of claim 1, wherein each optical detector is configured to detect each corresponding weighted vector element to form a plurality of optical detection signals.

8. The system of claim 1, further comprising an electronic receiving unit configured to receive the matrix and to receive the vector.

9. A system comprising:
a light projector configured to emit a plurality of light signals, each light signal corresponding to a first vector element of a first vector comprising a plurality of first vector elements and having dimensionality L×1;
an optical fan-out module configured to form M copies of the plurality of light signals;
an optical modulator configured to, for each copy of the plurality of light signals, apply at least one modulation weight to the plurality of first vector elements to form a plurality of weighted vector elements, the at least one optical modulation weight corresponding to at least one first matrix element in a subregion of a first matrix comprising a plurality of first matrix elements and having dimensionality M×L;
a plurality of optical detectors configured to, for each copy of the plurality of light signals, detect an optical detection signal corresponding to a sum of the plurality of weighted vector elements; and
an output module configured to, for each copy of the plurality of light signals, output the optical detection signal as a second vector element of a second vector having dimensionality M×1.

10. The system of claim 9, wherein the light projector comprises a plurality of incoherent light emitters or a plurality of coherent light emitters.

11. The system of claim 9 wherein the optical fan-out module comprises one or more lenses, kaleidoscopes, diffractive optical elements, or beam splitters.

12. The system of claim 9, wherein each optical detector is configured to detect the corresponding optical detection signal.

13. The system of claim 9, wherein each optical detector is configured to detect each corresponding weighted vector element to form a plurality of optical detection signals.

14. The system of claim 9, further comprising an electronic receiving unit configured to receive the matrix and to receive the vector.

15. A system comprising:
an electronic receiving unit configured to receive a first matrix comprising a plurality of first matrix elements and having a dimensionality M×L and to receive a first vector comprising a plurality of first vector elements and having dimensionality L×1;
a light projector configured to emit a plurality of light signals, each light signal corresponding to a first vector element of a first vector;
a fan-out module configured to form M copies of the plurality of light signals;
an optical modulator configured to, for each copy of the plurality of light signals, apply at least one modulation weight to the plurality of first vector elements to form a plurality of weighted vector elements, the at least one optical modulation weight corresponding to at least one first matrix element in a subregion of the first matrix;
a plurality of optical detectors configured to, for each copy of the plurality of light signals, detect an optical detection signal corresponding to a sum of the plurality of weighted vector elements; and an output module configured to, for each copy of the plurality of light signals, output the optical detection signal as a second vector element of a second vector having dimensionality M×1.

16. The system of claim 15, wherein the light projector comprises a plurality of incoherent light emitters or a plurality of coherent light emitters.

17. The system of claim 15, wherein the fan-out module comprises an optical fan-out module.

18. The system of claim 17, wherein the optical fan-out module comprises one or more lenses, kaleidoscopes, diffractive optical elements, or beam splitters.

19. The system of claim 15, wherein each optical detector is configured to detect the corresponding optical detection signal.

20. The system of claim 15, wherein each optical detector is configured to detect each corresponding weighted vector element to form a plurality of optical detection signals.
